(19) United States
(12) Patent Application Publication
(10) Pub. No.: US 2011/0070058 A1
(43) Pub. Date: Mar. 24, 2011

(54) Magnetic Lifting Assembly

(75) Inventor: Don Lindstrom, Elk Grove Village, IL (US)

(73) Assignee: BUNTING MAGNETICS CO., Newton, KS (US)

(21) Appl. No.: 12/565,059

(22) Filed: Sep. 23, 2009

(51) Int. Cl. B66F 9/12

(52) U.S. Cl. 414/592

(57) ABSTRACT

A magnetic lifting assembly for a fork lift vehicle auxiliary implement, the vehicle having a pair of laterally spaced lift tines, the magnetic lifting assembly comprising a cross beam; lateral tine receiving means fixedly attached to the cross beam's lateral end, the lateral tine receiving means being adapted for receiving one of the fork lift vehicle's lift tines; oppositely lateral tine receiving means fixedly attached to the cross beam's oppositely lateral end, the oppositely lateral tine receiving means being adapted for receiving the fork lift vehicle's other lift tine; a permanent magnet fixedly attached to the cross beam, the permanent magnet emanating a magnetic field downwardly from the cross beam; and magnetic strength varying means connected operatively to the permanent magnet, the magnetic strength varying means being adapted for alternatively increasing and decreasing the strength of the downwardly emanated magnetic field.

### FIELD OF THE INVENTION

This invention relates to magnetic lifting apparatus. More particularly, this invention relates to such apparatus which are adapted for use as an auxiliary implement to a fork lift truck or loader vehicle.

### BACKGROUND OF THE INVENTION

Known magnetic lifting assemblies which are attachable for use as an auxiliary implement upon the lift tines of a fork lift truck are functionally deficient and have limited utility due to their electro-magnetic mode of operation. Such known assemblies undesirably require mounting of bulky electric storage batteries upon the auxiliary implement or require extensions of electric power cables to the implement, both configurations limiting the function and usefulness of the implement for lifting and moving heavy ferrous items.

The instant inventive magnetic lifting assembly solves or ameliorates problems discussed above by providing an implement which incorporates a permanent magnet which emanates a downwardly extending magnetic flux field, and which further incorporates a rotatable magnetic armaturing element which allows the permanent magnet to function in the manner of an electromagnet having an on/off power switch.

### BRIEF SUMMARY OF THE INVENTION

The instant inventive magnetic lifting assembly preferably is configured and adapted for use as a fork lift vehicle auxiliary implement, such vehicle typically having a pair of lateral spaced and forwardly extending lift tines. Such tines typically comprise heavy duty steel.

A base structural component of the inventive magnetic lifting assembly comprises a cross beam having left and right or lateral and oppositely lateral ends. Preferably, the cross beam comprises steel. Suitably, the cross beam may alternatively comprise aluminum. In a preferred embodiment, the cross beam is configured as an upwardly opening “C” channel or “U” beam. Provision of the “U” configured cross beam advantageously provides a flat land or undersurface for abutting and underlying attachments of a permanent magnet assembly and tine receiving brackets or sleeves, as are discussed below.

The magnetic lifting assembly preferably further comprises lateral and oppositely lateral tine receiving means which are respectively fixedly attached to the lateral and oppositely lateral ends of the cross beam, such means are preferably abuttingly attached to the undersurface of the cross beam.

In a preferred embodiment of the instant invention, such tine receiving means comprise a pair of laterally oblongated sleeves which are fitted for receipt of the paired lift tines of a fork lift truck. Suitably, the lateral and oppositely lateral tine receiving means may alternatively comprise paired “L” brackets whose stems and flanges form and define tine receiving and capturing spaces. Also suitably, though less desirably, the tine receiving means may comprise tine receiving channels which are presented at and open downwardly at the lateral and oppositely lateral ends of the cross beam.

In order to secure a fork lift's paired tines within the instant invention's tine receiving means, tine clamping means are preferably mechanically associated with the tine receiving means. Where the tine receiving means comprise, as preferred, laterally oblongated tine receiving sleeves, the tine clamping means preferably comprise manually turnable set screws which are received within and extend through internally helically threaded apertures within side walls of such sleeves. Suitably, the tine clamping means may alternatively comprise lever actuated pressure cam assemblies. Also suitably, such means may alternatively comprise lever actuated over center clamp assemblies.

A further structural component of the instant inventive magnetic lifting assembly comprises a permanent magnet which is preferably fixedly attached by means of bolts to the cross beam. Such magnet is preferably arranged so that it extends downwardly from the undersurface of the cross beam, and so that it is positioned between the lateral and oppositely lateral tine receiving means. Preferably, the permanent magnet is of the type which houses sub-magnets within a casing and which operatively incorporates within the casing a rotatable magnetic armaturing element. The rotatable magnetic armaturing element is preferably externally actuatable by a turn lever. Upon lever actuated rotation of the armaturing element, the permanent magnet is advantageously influenced so that the magnet's field alternatively downwardly emanates effective “on” position and “off” position magnetic strengths. Such lever actuated rotatable armaturing element constitutes a preferred magnetic strength varying or “on/off” effect means. Suitably, other magnetic strength varying means such as rotatable or pivotable mounts of an entire permanent magnet assembly may be utilized.

In use of the instant inventive magnetic lifting assembly, the assembly may initially rest upon, for example, a metal working machine shop's floor. An operator utilizing the assembly may drive a fork lift truck forwardly toward the rear of the assembly, causing the forward or distal ends of the fork lift truck's lift tines to enter, slidably pass through and become laterally and vertically captured within the assembly's lateral and oppositely lateral tine receiving means. Thereafter, the operator may actuate the assembly's tine clamping means to securely clamp the assembly upon the tines, preventing the assembly from slidably moving forwardly or rearwardly with respect to the tines. Thereafter, the operator may raise the tines and may drive and maneuver the fork lift truck to vertically position the magnetic lifting assembly directly over an iron or steel article which is in need of transport and repositioning. Upon such positioning, the tines may be lowered, placing the magnetic lifting assembly in contact with such article. Thereafter, the operator may manually turn the assembly's preferable lever actuated magnetic strength varying means to the magnet's “on” position in order to establish a secure magnetic connection between the iron or steel article and the assembly. Thereafter, the operator may advantageously actuate the fork lift truck to raise in unison the tines, the magnetic lifting assembly, and the iron steel article. Thereafter, the operator may drive the fork lift truck to an offloading point such as a raised storage rack. A reversal of steps described above advantageously releases and deposits the iron or steel article at the desired new location.

Accordingly, objects of the instant invention include the provision of a magnetic lifting assembly which includes and incorporates structural features as described above, and which arranges those structures and features in manners described above for purposes of facilitating beneficial functions, as described above.

Other and further objects, benefits, and advantages of the present invention will become known to those skilled in the art upon review of the Detailed Description which follows, and upon review of the appended drawings.

### BRIEF DESCRIPTION OF THE DRAWINGS

FIG. 1 is a perspective view of the instant inventive magnetic lifting assembly.

FIG. 2 is a front plan view of the magnetic lifting assembly.

FIG. 3 is a view of the undersurface of the magnetic lifting assembly.

### DETAILED DESCRIPTION OF A PREFERRED EMBODIMENT

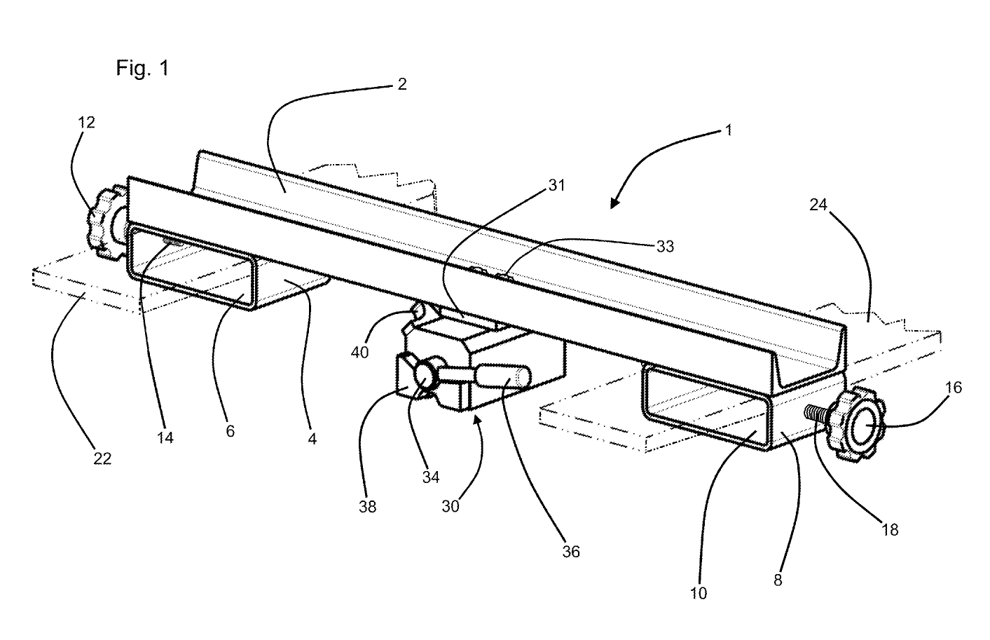

Referring now to the drawings, and in particular to FIG. 1, a preferred embodiment of the instant inventive magnetic lifting assembly is referred to generally by Reference Arrow 1. The assembly 1 is preferably utilized as an auxiliary lifting implement upon a common fork lift loader or truck vehicle, such vehicle having paired laterally spaced and forwardly extending lift tines. Forward or distal ends of such tines are designated in broken lines upon Drawing FIG. 1 and are identified by Reference Numerals 22 and 24.

Referring further to FIG. 1, a major structural component of the inventive assembly comprises a cross beam 2 which preferably comprises a length of “C” channel steel. Preferably, the beam 2 is oriented in a “U” configuration as indicated in FIG. 1. Such orientation advantageously allows the forward and rearward flanges of such beam to extend upwardly for resisting buckling of the beam while the beam is under load. Such orientation also advantageously allows the broad undersurface of the horizontally extending web of the beam 2 to present a convenient land for abutting attachment thereto of tine sleeve and magnet structures which are described below.

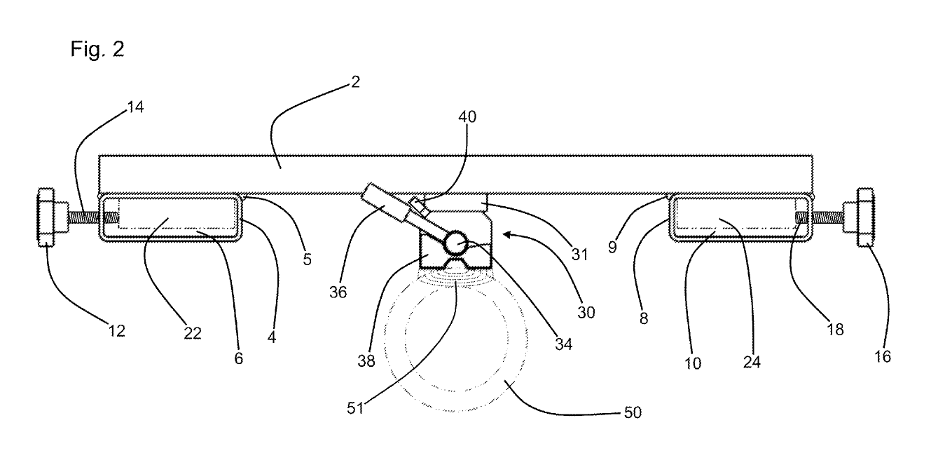

Referring simultaneously to Drawing FIGS. 1 and 2, lateral tine receiving means are provided, such means being represented by a laterally oblongated tine receiving sleeve 4. Such sleeve 4 defines a forwardly extending hollow bore 6 which is fitted for receipt of the lift tine 22. Oppositely lateral tine receiving means represented by a second oblongated sleeve 8 are also provided, such means, like the sleeve 4, defining a bore 10 which similarly receives an oppositely lateral tine 24. The sleeve configured lateral and oppositely lateral tine receiving means 4 and 8 are considered to be representative of other suitable alternative structures which are capable of receiving and capturing lift tines 22 and 24 such as “L” brackets or guides (not depicted) and slide channels (not depicted). The lateral and oppositely lateral lift tine receiving sleeves are preferably fixedly attached to the lateral and oppositely lateral ends of the undersurface of the cross beam 2 by means of welds 5 and 9.

Referring further simultaneously to FIGS. 1 and 2, the instant inventive magnetic lifting assembly preferably further comprises tine clamping means, such means preferably comprising lateral and oppositely lateral helically threaded shafts 14 and 18, such shafts 14 and 18 being threadedly received within internally helically threaded apertures extending laterally through the outer side walls of the sleeves 4 and 8. Turning means, preferably in the form of manually turnable knobs 12 and 16, are preferably fixedly attached to the outer ends of the threaded shafts 14 and 18. In use of the inventive assembly, such turn knobs 12 and 16 may be manually turned and counter turned for alternatively tightening their shafts' inner ends against the outer side walls of the lift tines 22 and 24. Compressive clamping forces exerted by the shafts 14 and 18 secures the tines 22 and 24 within the bores 6 and 10 of the sleeves 4 and 8. Counter turning of knobs 12 and 16 advantageously allows the assembly 1 to be forwardly slidably removed from their engagements with the lift tines 22 and 24. The tine clamping means depicted in FIG. 2 as combinations of helically threaded apertures, threaded shafts 14 and 18 and turn knobs 12 and 16 are considered as representative of other commonly known clamping and article securing mechanism such as lever actuated pressure cams (not depicted) and over center latches (not depicted).

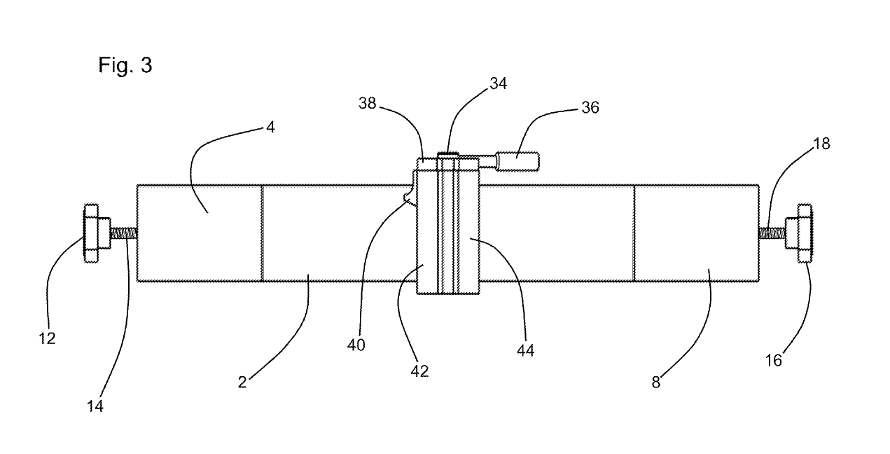

Referring to FIGS. 1 and 2, a permanent magnet component of the instant inventive magnetic lifting assembly is referred to generally by Reference Arrow 30. The permanent magnet 30 preferably comprises and encases a longitudinally extending bank of permanent horseshoe sub-magnets whose north and south poles are downwardly oriented to communicate with. Referring further to FIG. 3, lower contact faces 42 and 44 of the magnet assembly 30 downwardly emanate a vector magnetic field 51. In order to ascribe to the permanent magnet 30, an effective “on/off” function similar to that achieved through electrical switching of an electro-magnet, a rotatable magnetic field armaturing element is preferably additionally mounted within the casing of the permanent magnet 30. Such armaturing element preferably rotates about axle 34 and may be manually actuated by turn lever 36. Upon pivoting movement of the turn lever 36 to its off position, as depicted in FIGS. 1 and 3, such internal rotatable element internally shunts or armatures the lines of magnetic flux between the magnets' poles, resulting in a substantial reduction of the strength of the downwardly emanated magnetic field 51. Alternatively, upon opposite pivoting movement of the turn lever 36 to its “on” position, as depicted in FIG. 2, such rotatable armaturing element ceases armaturing and shunting the magnetic field, resulting in an increase of the strength of the magnetic field 51. The permanent magnet 30 preferably further presents a rotation stop 38 which selectively and alternatively stops the rotation of the turn lever 36 in its “off” or “on” position. Also, the permanent magnet 30 preferably further includes a slide latch 40 which, upon movement of the turn lever 36 to its on position, may be forwardly slidably moved to securely hold the lever 36 in its “on” position.

Referring simultaneously to all figures, the permanent magnet 30 is preferably fixedly and removably attached to the undersurface of the cross beam 2 by means of an apertured mounting spacer 31, and by means of mounting bolts 33.

Referring to FIG. 1, in use of the instant inventive magnetic lifting assembly 1, such assembly may initially rest upon a floor surface. Thereafter, an operator may drive and position a fork lift truck so that its laterally paired lift tines 22 and 24 extend forwardly through the bores 6 and 10 of the sleeves 4 and 8. Thereafter, the operator may tighten knobs 12 and 16 to secure the tines 22 and 24 within the channels 6 and 10. Thereafter, the operator may operate the fork lift truck to raise the tines 22 and 24, raising the magnetic lifting assembly 1 with such tines. Thereafter, referring further to FIG. 2, the operator may drive the fork lift truck and may position the assembly 1 over an iron or steel item to be lifted by the assembly 1 such as an exemplary steel pipe 50. Thereafter, the operator may lower the tines and may move lever 36 from its “off” position to the “on” position depicted in FIG. 2, such movement causing magnetic field 51 to emanate downwardly for securely magnetically engaging the pipe 50. Thereafter, the operator may raise the tines drive the fork lift truck and the magnetic lifting assembly along with the pipe 50 to a desired off-loading location. Reversal of steps described above efficiently off-loads the pipe 50 at the desired location.

While the principles of the invention have been made clear in the above illustrative embodiment, those skilled in the art may make modifications in the structure, arrangement, portions and components of the invention without departing from those principles. Accordingly, it is intended that the description and drawings be interpreted as illustrative and not in the limiting sense, and that the invention be given a scope commensurate with the appended claims.

I claim:

1. A magnetic lifting assembly for use as a fork lift vehicle auxiliary implement, the fork lift vehicle having a pair of laterally spaced and forwardly extending lift tines, the magnetic lifting assembly comprising:
(a) a cross beam having a lower surface, a lateral end, and an oppositely lateral end;
(b) lateral tine receiving means fixedly attached to the cross beam's lateral end, the lateral tine receiving means being adapted for receiving one of the fork lift vehicle's lift tines;
(c) oppositely lateral tine receiving means fixedly attached to the cross beam's oppositely lateral end, the oppositely lateral tine receiving means being adapted for receiving the fork lift vehicle's other lift tine;
(d) a permanent magnet fixedly attached to the cross beam, the permanent magnet emanating a magnetic field downwardly from the cross beam; and
(e) magnetic strength varying means connected operatively to the permanent magnet, the magnetic strength varying means being adapted for alternatively increasing and decreasing the strength of the downwardly emanated magnetic field.

2. The magnetic lifting assembly of claim 1 wherein the permanent magnet extends downwardly from the cross beam's lower surface.

3. The magnetic lifting assembly of claim 2 wherein the permanent magnet is positioned between the lateral and oppositely lateral tine receiving means.

4. The magnetic lifting assembly of claim 3 wherein the magnetic strength varying means comprises a rotatable magnetic field armature.

5. The magnetic lifting assembly of claim 4 wherein the magnetic strength varying means further comprises a turn lever connected operatively to the rotatable magnetic field armature.

6. The magnetic lifting assembly of claim 1 further comprising tine clamping means connected operatively to the lateral and oppositely lateral tine receiving means, the tine clamping means being adapted for alternatively securing the cross beam and the permanent magnet upon the fork lift vehicle's lift tines, and releasing the cross beam and permanent magnet from the fork lift vehicle's lift tines.

7. The magnetic lifting assembly of claim 6 wherein each tine receiving means comprises a laterally oblongated sleeve.

8. The magnetic lifting assembly of claim 7 wherein each laterally oblongated sleeve has a side wall, and wherein the tine clamping means comprise set screws and screw receiving eye combinations, said combinations extending through the laterally oblongated sleeves' side walls.

9. The magnetic lifting assembly of claim 8 wherein each set screw has an outer end, and further comprising turning means connected operatively to the set screws' outer ends.
